(19) United States
(12) Patent Application Publication
(10) Pub. No.: US 2006/0262547 A1
(43) Pub. Date: Nov. 23, 2006

(54) Delivery System for Removable Lamp

(76) Inventors: Karlheinz Strobl, Mt. Sinai, NY (US); Li Shen, Bohemia, NY (US)

Correspondence Address: LILLIE LAW, LLC, 269 SOUTHPORT ST, RONKONKOMA, NY, 11779, US

(21) Appl. No.: 11/419,976

(22) Filed: May 23, 2006

Related U.S. Application Data
(60) Provisional application No. 60/683,640, filed on May 23, 2005.
(60) Provisional application No. 60/689,474, filed on Jun. 10, 2005.
(60) Provisional application No. 60/693,596, filed on Jun. 25, 2005.

(51) Int. Cl. F21S 8/06

(52) U.S. Cl. 362/408

(57) ABSTRACT

The present invention is directed to a protective lamp delivery system that enables, inter alia, end-users to replace a lamp inside a lamp reflector module in a “safer” way, in particular, this invention pertains to the field of micro display based projection display systems and fiber optic light sources.

### RELATED APPLICATION(S)

This application is related and claims priority to provisional applications (i) having Ser. No. 60/683,640 filed 23 May 2005, (ii) having Ser. No. 60/689,474 filed 10 Jun. 2005 and (iii) having Ser. No. 60/693,596 filed 25 Jun. 2005.

### BACKGROUND

1. Field of Invention

The present invention is directed to the design and manufacturing of a protective lamp delivery system that enables, inter alia, end-users to perform a “safer” lamp replacement in the field of projection display systems and fiber optic illumination systems.

2. Description of Background

A lamp assembly for a projection display system typically comprises a lamp housing, a reflector system, an electrical connection system, and a lamp. When only a lamp with a prealigned mounting socket is being replaced by an end user instead of the total lamp assembly, the cost of a lamp replacement can be, in principle, significantly reduced. However, such a lamp exchange, when implemented with prior art technology, can lead to potentially new problems.

The envelope of the lamp is typically sensitive to finger prints, which if incidentally left thereon, for example, during installation, can lead to, inter alia, an accelerated weakening of the envelope wall, wherein such acceleration is likely to precipitate a premature envelope fracture, whether during the normal operation of the lamp or even during its startup phase. During normal operation of an arc lamp, the mechanical fragility of the envelope structure increases with age due to increased quartz devitrification. Hence, this combined with the fact that most arc lamps have a much higher than atmospheric gas pressure during normal operation, and in particular the short arc Xe lamp types often have a higher than atmosphere fill pressure even when not operated, any handling of the lamp having such weakened envelope structure can yield a fracture of the envelope, and potentially personal injuries. Therefore the handling of bare lamps, whether during their installation and/or, more importantly, during their removal, is critical, as such handling effects not only the maximum achievable lamp lifetime, but also potentially exposes the person removing the lamp to sharp glass pieces and/or Hg vapors, among other possible health risks.

In low volume industrial fiber optic light source applications (for example, UV curing light sources, cinema projectors, etc.), depending on the illumination equipment design, sometimes only a non-prealigned lamp is replaced at the end of its life. In this case, a trained technician would first remove the aged lamp carefully and then install a new lamp, onto an adjustable lamp holder. Thereafter, the technician aligns the lamp with respect to the reflector; to minimize output losses caused by misalignment. However, for high volume, consumer type illumination products, like home entertainment micro display projection display systems, alignment of a replacement lamp by the consumer (an end user) in addition to the expense of training an end user in safe handling an unprotected lamp, has thus far been impractical based on current illumination technology. It is in this light, that the projection display industry has accepted as a norm the design constraints that the entire lamp assembly would need to be replaced at the end of the lamp life, whether by an end-user or a service technician. This is an inefficient use of resources and adds a significant increase to the cost of ownership, i.e. at typically 15-40% of the cost of a new product.

The replacement of a lamp alone, for example, inside an elliptical reflector, has been disclosed in U.S. Pat. Nos. 5,506,464; 5,957,571; and 5,497,049 issued to Philips, having specially designed reflector shapes with a matching mounted, high-pressure Hg short arc lamp. However, in these as well as other patents, references are limited to special alignment features between a lamp that has been pre-aligned and cemented to a lamp socket incorporating respective alignment features; and a reflector having matching mechanical preparations thereby enabling alignment between the mounted lamp and the reflector housing resulting in reduced lamp position error. However, there is an absence of any reference disclosed as to how the lamp exchange process may be made sufficiently “safe” for consumer end user installers.

U.S. Pat. No. 6,356,700 issued to Strobl (hereafter '700 to Strobl), to an inventor of the present invention discusses the utilization of eele-enhanced® reflectors. The SID 2005 paper, P150 discusses the concept of an end-user removable lamp in connection with an eele-enhanced® reflector. However, it does not disclose how such an exchange can be performed sufficiently “safe” by an end-user, Thus, while '700 to Strobl enables a double-sided mounted Lamp-Reflector combination that is about 2×less sensitive to the lamp/reflector alignment (than elliptical or parabolic reflectors), and that, because of its double end mounting system is also much less sensitive to operator mounting errors, and therefore makes such an end user replaceable lamp option more practical, there still is a need to provide a lamp replacement method and/or system that makes an end-user replaceable lamp option sufficiently “safe” for the consumer projection and fiber optic illumination field.

Therefore, it is first advantage of the present invention to enable an end-user to replace a removable lamp mounted in a lamp reflector module in a safer manner.

It is second advantage of the this invention to enable a low cost replacement option of the lamp when it is aged while minimizing the risk of injury to the end-user due to an accidental integrity failure of the lamp envelope during the removal or installation process.

It is a third advantage of this invention to enable the utilization of lower cost, higher power shorter life, arc lamps in high usage applications, such as in consumer projection televisions thereby reducing the average cost of projector usage.

It is a fourth objection of this invention to combine the eele-enhanced® Lamp reflector module technology with an end-user replaceable arc lamp and with an installation/removal tool (protective enclosure) that increases operator safety.

### SUMMARY OF THE INVENTION

The present invention is directed to a delivery system that provides a “safer”, lamp replacement inside a lamp assembly and in particular, for use in combination with an elliptical, a parabolic and/or eele-enhanced® reflectors.

In a first embodiment of the present invention, the combination of a collapsible protective enclosure and the reflector system encloses at least the critical portion of the lamp installation, i.e. until the lamp with its respective mounting socket or sockets is fully seated in a respective lamp holder or when it respectively is being removed from its lamp holder. The preferred removal process according to this invention is performed when the lamp has cooled down to room temperature to minimize any pressure inside the lamp envelope leading to envelope fractures.

For example, for an elliptical, parabolic or for an eele-enhanced® reflector system where a single or double side mounted lamps is inserted through a lamp access port (hole in the reflector surface) in the direction of the lamp axis into the reflector system, a collapsible protective enclosure encloses the lamp right outside the reflector which collapses/expands during the final/beginning reflector insertion/removal step to allow 100% side enclosure of the lamp during the installation/removal process. A suitable removable lid in connection with the collapsible enclosure completes the full enclosure for transportation.

In a second embodiment of the present invention, the reflector system is opened and the lamp is inserted substantially perpendicular to the lamp axis while its critical surface is being enclosed with a non collapsible protective enclosure, that can be opened/closed as needed by the end user replacing the lamp. For example, the primary reflector of the eele-enhanced® reflector system is removed providing direct access to the mounting system of a double side mounted lamp, weather the mounting system is an integral part of the retro reflector or not. Alternatively, the elliptical or parabolic reflector can be made from at least two portions that separate in a plane substantially enclosing the lamp axis and thus provide direct access to the lamp axis and to a respective mounting system from a direction that is perpendicular to the lamp axis. The protective enclosure is used to surround the exposed envelope and to grab the mounted lamp (preferable at the lamp posts or sockets level alone), thus preventing any physical contact with the lamp envelope. The lamp socket(s) is (are) then removed from a respective lamp holder, all the while the envelope is fully enclosed by the protective enclosure.

If the envelope fractures during the removal process (whether due to excess mechanical force and/or due to a weakened mechanical structure) the protective enclosure enclosing the lamp at a minimum 100% in the direction perpendicular to the lamp axis near the envelope center section will prevent any significant quartz particle from coming in contact with the end user. Optionally, the closed protective enclosure is also gas or liquid tight, thereby minimizing the exposure of the end-user to possible Hg vapors or droplets.

In this manner, accidental end user contact of the critical envelope surface of the lamp is prevented. This maximizes lamp life by minimizing chances of envelope surface contaminations during the installation process. It also improves end user safety by minimizing exposure of the end user to possible harmful components of a fractured lamp (sharp quartz pieces, Hg content, etc, whether they break or are ejected from the envelope center with our without kinetic energy associated with a possible envelope rupture during the installation/removal/transport process (typically only Xe lamps are under pressure when they are at room temperature).

In another preferred embodiment of this invention, the protective enclosure contains chemical(s) that bind liquid Hg, thus further minimizing exposure of the individual servicing the lamp, to low-level Hg vapors exposure. Moreover, the inside of a respective protective removal enclosure (removal tool) may also be covered with a soft material, having the characteristics of rubber, and/or stick (gooey) material that bonds all materials that come in contact therewith, thereby minimizing the chance that anything can exit the protective enclosure.

Optionally, for additional end-user safety, the respective illumination system has an access door that is interlocked with a thermal switch preventing access to the lamp assembly, until a minimum cool down temperature of the lamp has been reached. Preferably, the protective enclosure is transparent to allow the end-user to visually check the integrity of the lamp inside the protective enclosure. It is envisioned that the protective removal enclosure be optionally used to ship the removed lamp to a proper environmental disposal site. It is further envisioned that in the case of a new lamp, the new lamp may either be prepackaged as enclosed in a protective delivery enclosure for shipment, or separately, whether or not in the same package. Nonetheless wherein a respective protective enclosure can be inserted into the container to grab the lamp (preferably at the respective mounting sockets) in such a manner that the total envelope surface area is enclosed, and then this assembly is inserted into a respective lamp mounting holder, after which the protective enclosure is removed. Preferably the size of the protective enclosure is such that the projector lamp access door can not be closed if the protective jacket is accidentally left on the lamp by an end user after the lamp installation process is completed.

### BRIEF DESCRIPTION OF THE DRAWINGS

In order for the present invention to be clearly understood and readily practiced, the present invention shall be described in conjunction with the drawings set forth hereinbelow:

FIG. 1 illustrates a prior art protective enclosure for an automotive single end mounted arc lamp;

FIG. 2 illustrates a collapsible protective enclosure with a single end mounted Lamp;

FIG. 3 illustrates another collapsible protective enclosure with a single end mounted Lamp;

FIG. 4 illustrates a non collapsible protective enclosure surrounding a double end mounted Lamp;

FIG. 5 illustrates a 3D view of a double end mounted Lamp with protective enclosure plugged into an elle-enhanced® retro reflector;

FIG. 6 illustrates a further protective enclosure design for a double end mounted Lamp;

### DETAILED DESCRIPTION OF THE INVENTION

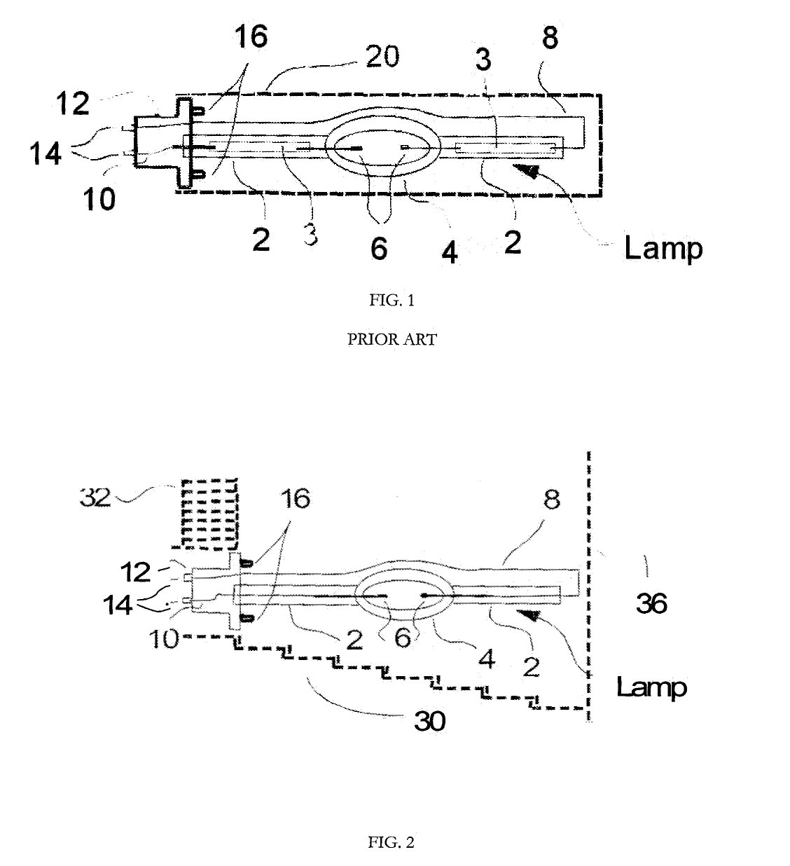

The present invention is directed to provide a delivery method and system that enables an end-user to replace a lamp inside a lamp reflector module in a safer way. In particular, this invention pertains to the field of micro display based projection display systems and fiber optic light sources. FIG. 1 illustrates a prior art delivery system for an automotive single end mounted arc lamp. The two lampposts 2, two Molybdenum foils 3, the envelope 4, and the two electrodes 6 together form the Lamp. The Lamp is electrically connected to the wires 8 and 10, and to a mounting socket 12, which has external electrical connections features 14 and alignment features 16 to help locate the electrode tips to the optimum alignment position with respect to a reflector with complimentary alignment features that match with the alignment features 16.

A transportation/shipping enclosure 20 encloses the Lamp and mechanically interlocks to the socket 12, for example, through a thread on the socket 12. Prior to installation, the shipping/transportation enclosure 20 must be removed, and the Lamp is thereafter inserted through a hole in the back of the reflector (access port) while the envelope 4 is exposed. Thus, in this common prior art delivery system, the envelope 4 is exposed while it is being inserted into the reflector, providing the opportunity for a finger print to be left thereon by the installer or for the installer scratching the envelope surface at the access port, thereby potentially compromising the integrity thereof, such as the maximum achievable lifetime of the replaced installed lamp or exposing the installer to possible personal injuries as set forth above.

FIG. 2 illustrates a first embodiment of the present invention applied to a single end mounted arc lamp. A collapsible protective enclosure 30 preferably transparent surrounds the Lamp both during shipping/transportation and during the insertion into the reflector. When the Lamp is inserted into the reflector, the enclosure 30 collapses progressively with the insertion progress into the shape of stacked cylinders, also shown in FIG. 2 as collapsed protective enclosure 32. In this manner the insertion delivery is made safer for an end-user since either the enclosure 30 or the reflector is enclosing the critical portion of the envelope 4 (at a minimum perpendicular to the Lamp axis X) during the insertion/removal step. Similarly in another preferred embodiment of the present invention, an initially collapsed enclosure 32 is placed near the reflector and used to extract a used Lamp from the reflector, while simultaneously the enclosure 32 extends into the full-extended mode 30. After a lid 36 has been placed over the end of the extended enclosure 30, the extracted Lamp is substantially fully enclosed again and safely transportable to an appropriate disposable site. Optionally, in another preferred embodiment of the present invention the enclosure 30 will contain Hg absorbing chemical(s) absorbing or binding most of the escaping Hg liquid in case of a fracture of the envelope during the transport phase.

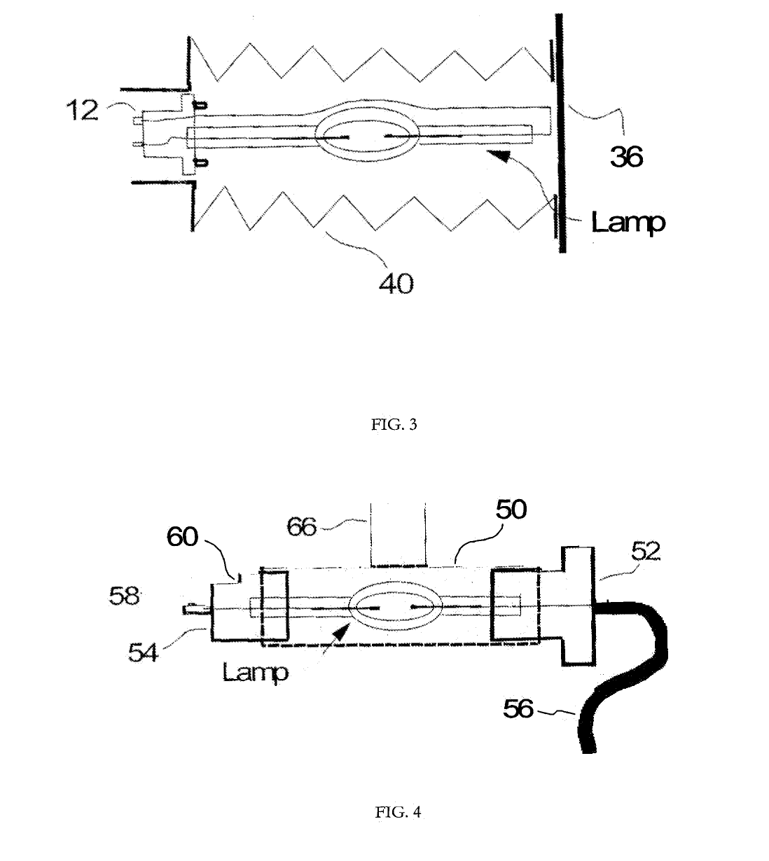

FIG. 3 illustrates another preferred embodiment of the present invention for a single end mounted Lamp where the collapsible enclosure 30 shown in FIG. 2 has been replaced by a harmonica type collapsible protective enclosure 40. Preferably, the collapsible enclosure 30 or 40 is made from at least a semi-transparent material.

FIG. 4 describes a side view of still another preferred embodiment of the present invention, wherein a double end mounted Lamp is enclosed by a removable, non-collapsible, protective enclosure 50. In this embodiment, two different types of lamp sockets (ferrules) are shown 52 and 54, wherein a first socket 52 illustrates a generic lamp socket. The socket 52 can be made from a conductive or non-conductive material, depending on the material of the reflector and/or the matching lamp holder, which mechanically holds or limit the location/orientation of the sockets 52, 54 in such a manner that the factory prealigned lamp is positioned accurately near the first focal point of a respective light collecting reflector, thus enabling an alignment free lamp installation. FIG. 4 further illustrates the right mounting socket 52 when made from a non-conductive material (for example, a ceramic material) having a disk like end feature designed to increase the path length from the connection cable 56 to the next ground location (not shown). Socket 54 illustrates the option where the electrical connection pin 58 is used to provide the electricity to the Lamp through an appropriated high voltage and high temperature capable connector plug (i.e., plug in, clip on, screw on, etc.) as opposite to the direct (no connector) high voltage cable 56 connection shown for the 52 socket. The Lamp can also be held in location against a respective reference mounting position with spring like clips by two respective electrical connection pins 58, one for each socket 52 and 54. Each socket can be assembled from one or more sub-components. The alignment feature 60 or the socket 54 represents one possible embodiment of a lamp positioning keying system wherein a step-in feature in the socket 52 (for example, metal, ceramic, quartz, glass, etc.) is being used here as basic example of one of the possible options of a simple axial (in the direction of the lamp axis) limiting alignment feature, and where a respective matching alignment step-out in respective lamp ferrule holder assures the proper X-axis alignment distance of the electrode gap center to the respective reflector focal point. Preferably both lamp sockets 52 and 54 have suitable keyed alignment features that enable the transfer of an accurate lamp alignment position from the lamp factory, where the lamp has been aligned properly inside the sockets 52 and 54 and cemented permanently into them, to the lamp mounting system of the end user. With a suitable keyed lamp mounting system, a prealigned Lamp, with a precise mechanical relationship between its mechanical key locating features and its optical center can be replaced easily by the end user without any lamp to reflector system alignment function needed to be done, all the while being protected by the protective enclosure 50.

A handle 66 can be used to facilitate the insertion or removal of the enclosure 50. Preferably the enclosure 50 is in mechanical tight contact with the Lamp only near the inside ends of the respective sockets 52.

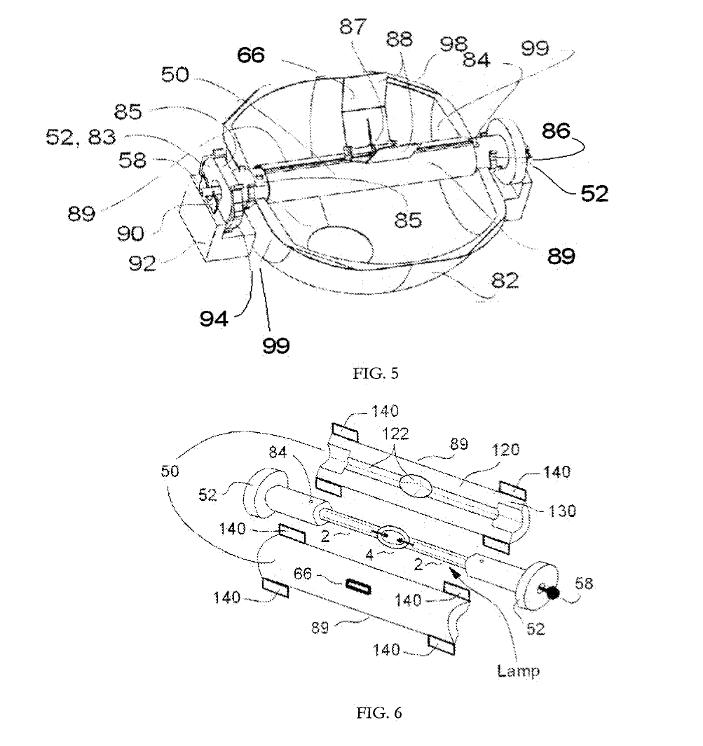

FIG. 5 illustrates a 3D view of a protective enclosure 50 of the present invention including the Lamp, an reflector 82 of an eele-enhanced® reflector system and two different types of double end mounting sockets 52 and 83. An optional cement filling hole 84 facilitates the delivery of cement into the hollow mounting socket 52, thus allowing to secure the lamp post 2 (see FIG. 4, hidden by the protective enclosure in FIG. 5) in an optimum spatial location with respect to respective spatially keyed alignment features of the sockets 52 and 54. The mounting socket 83 is illustrated here in another preferred embodiment of the present invention, wherein a further alignment feature 85 is put on the front (away from the retro reflector 82) of the socket 83 to facilitate the proper axial orientation of the Lamp with respect to the enclosure 50, thus facilitating the Lamp insertion at the same axial lamp orientation as the Lamp was cemented into the sockets 52 at the lamp factory. Optionally, the enclosure 50 is mechanically contacting the rotational alignment key feature 85 to assure proper rotational lamp axis orientation during the Lamp installation (not shown in FIG. 5). Also shown are optional mounting clips 86 that hold the sockets 52 in place and that are mechanically connected to the retro reflector 82. Moreover, the handle 66 is illustrated as a spring 87 loaded double-armed handle 88, which facilitates the operation of the two jaws 89, which comprise the protective enclosure 50 and enable it to stay closed until pressed by the installer at the end/beginning of the installation/removal process. Optionally, the handle 66 further includes a mechanism for locking the two opening jaws together for one time use only (for example for the removal version of the protective enclosure 50).

The electrical pins 58 are connected to an optional spring clip electrical connection 90 that is mounted onto a lamp support holder 92 which is part of a lamp mounting system that has a fixed precise mechanical relationship to the first focal point F1 of the eele-enhanced® reflector of which reflector 82 is a component of. Optionally, the sockets 52 can also be held with a clip 86 outside the reflector body or the electrical connection 90 is also providing mechanical spring forces to locate the electrical pin 58 against the holder 92 or retro reflector 82 to engage an axial location key 60. Alternatively, in another preferred embodiment, the protective enclosure 50 is shorter than the one shown in FIG. 5, wherein it clamps on to the lampposts 2 (hidden in FIG. 5 by the protected enclosure 50) and in lieu of grabbing the sockets 52 and 83.

In another preferred embodiment of the present invention, the protective enclosure 50 has at least one mechanical guide that aids in the insertion of the lamp into a respective mounting system. For example, by tapering the enclosure in the direction of the optical axis the flat sides 99 of the retro reflector 82 can help in guiding the lamp easier into the respective lamp holder 92 Similarly by adding suitable flat sections to the two halves that comprise the enclosure 50 mating flat section on the sockets 52 and 83 can be aligned to give an easy rotational alignment for the lamp inside the delivery enclosure 50.

FIG. 5 shows the split line between the upper and lower halves of the two jaws forming the protective enclosure 50 oriented an 0 deg in the Y-Z plane, with the Z axis being the optical axis of the reflector. Alternatively, another preferred embodiment of the present invention rotates this split line out form the horizontal plan to help with the ergonomic of the separation. For example, a rotation of 30-60 deg help separation of the two halves because the holder 66 no longer has to be lowered for the enclosure 50 to be removed from the Lamp after the installation is completed. In another preferred embodiment of the present invention, the reflectors have build in lamp alignment features that are integral part of the manufacturing process. For example, some or all of 5 point locating features in the X axis and in the Y and Z axis for lamp sockets 52 and 83 can build into the body of an electroformed eele-enhanced® retro reflector 82

FIG. 6 illustrates an alternative embodiment of the present invention, namely a further variation of a protective enclosure 50; wherein said enclosure 50 comprises a plurality of sections 89 which substantially enclose the lamp, whether during installation or removal and include conforming shapes 122 matching the shape of the Lamp. It is envisioned, that the enclosure 50 may be designed to be used only once, i.e., disposable, as it may be disposed of with the spent lamp. Nonetheless, each section 89 comprises surface 120 that is optionally covered with adhesive material 130 (for example adhesive tape), wherein the shape 122 may be optionally covered with a conforming material, such as rubber or a gooey material (for example, silicone or a slow drying glue) that surrounds the envelope 4 and the two lamp posts 2. The sections 89 optionally have interlocking and/or ratcheting features 140 that snap together easily, yet are more difficult to disassemble.

In the event of a mechanical failure of the envelope during the removal process or subsequent transport, the enclosure 50 and optionally the gooey material prevent any quartz particles from escaping. Moreover, usage of adhesive on the surfaces ensure liquid or quasi gas tight enclosure of the enclosure 50 about the lamp, thereby minimizing, if not eliminating the chance of Hg droplets or Hg vapor release. In addition, by further mixing the gooey material with Hg absorbing/bonding chemicals the chances of accidental release of Hg can be much reduced as well as lowering the risk of exposure to the end user and the environment during the transport of the fragile aged Lamp to a proper disposal site.

An alternative to the embodiment shown in the FIG. 6, the enclosure 50 may comprise a single molded body having a flex joint therein; and a respective optional removal handle 66. The gooey surface can be covered by a protective foil (for example, as is done with double-sided adhesive tape) which is removed prior to the removal of the Lamp. A similar system can be utilized for the installation process where the gooey material is not an adhesive, but is shock absorbing (for example silicone or rubber covered) and a respective handle mechanism enables the easy separation of the respective sections 89.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application both literally and in equivalents recognized at law.

1-10. (canceled)

11. A protective lamp delivery system comprising:
a removable double sided mounted arc lamp having an optical axis X, an envelope surrounding an optical arc center that is connected to two lamp posts, each post having a mounting socket with an electrical connection pin mounted rigidly thereto, wherein at least one of said mounting sockets being a keyed mounting socket having a first set of position features; wherein said keyed mounting socket and said arc center are in a fixed spatial relationship relative to the each other and having a spatial tolerance variation of less than 2 mm from lamp to lamp; and
a removable, non-collapsible protective enclosure which substantially surrounds said envelope center, at least a portion of said lamp posts perpendicular and along said lamp axis X during transport of said lamp; said first set of positioning features of said keyed mounting socket but covers less than 50% of said other mounting socket, and excludes covering said electrical connection pins.

12. A protective delivery system as in claim 1, where said keyed mounting socket is in a fixed spatial relationship with the focal spot of a reflector system having a lamp access port and where said removable enclosure is at least compatible with a scenario selected from the group consisting of:
a. an eele-enhanced® primary and retro reflector pair where the access ports include the removal of the primary reflector thereby giving direct access to said lamp axis, one part of the mounting system to the left and one to the right of said optical axis Z;
b. an elliptical reflector system comprised of an elliptical shaped reflector separated along the optical axis into a first and second half, the access port includes the removal of one of said halves providing means for direct access to said lamp axis, wherein one part of said mounting system is outside and one inside said reflector system; and
c. a parabolic elliptical reflector system of a parabolic reflector separated along the optical axis into a first and second half, said access port includes the removal of one of said halves reflectors providing means for direct access to said lamp axis, wherein one part of said mounting system is outside and one inside said reflector system and where when said lamp is inside said protective enclosure during at least one transport activity selected from a group comprising of:
i) delivery of said lamp to a reflector system to a respective lamp mounting system through a respective access port while said lamp is surrounded by said protective enclosure until said lamp is fully seated in said lamp mounting system; and
ii) removal of said lamp from a respective reflector system and its respective lamp mounting system though a respective access port with surrounding said lamp with said removable enclosure before removing it from said lamp mounting system and delivery of said lamp to a suitable disposal site while substantially enclosed by said enclosure.

13. A protective lamp delivery system as in claim 11, wherein at least a portion of the inner surface of said protective enclosure is covered with a glue-like substance that adheres to the envelope after closure.

14. A protective lamp delivery system as in claim 11, wherein at least a portion of the inner surface of said protective enclosure is covered with at least one chemical substance having a characteristic selected from the group consisting of: to absorb and bind Hg.

15. A protective lamp delivery system as in claim 11, wherein said protective enclosure is tapered toward the optical axis.

16. A protective lamp delivery system as in claim 11, wherein mechanical contact between said enclosure and said lamp is limited to a portion of at least one of said mounting sockets.

17. A protective lamp delivery system as in claim 11, wherein said protective enclosure has at least one ratcheting locking mechanism that prevents an unforced opening thereof.

18. A protective lamp delivery system as in claim 11, wherein said protective enclosure and said mounting socket had a second set of keyed alignment features that are configured and dimensioned so that said lamp and said protective enclosure uniquely and removable interlock.

19. A protective lamp delivery system comprising:
a removable mounted arc lamp having an optical axis X, an envelope surrounding an optical arc center that is connected to two lamp posts, at least one post having a mounting socket with an electrical connection pin mounted rigidly to thereto, with at least one mounting socket being a keyed mounting socket having a first set position features; wherein said keyed mounting socket and said arc center are in a fixed spatial relationship relative to the each other and having a spatial tolerance variation of less than 2 mm from lamp to lamp; and
a removable protective enclosure that is collapsible in the lamp axis direction and substantially surrounds both said envelope center and at least a major portion of said lamp posts perpendicular and along said lamp axis X during said the transport of said lamp.

20. A protective delivery system as in claim 19, where said keyed mounting socket is in a fixed spatial relationship with the focal spot of a reflector system having a lamp access port and lamp mounting system, and where said removable collapsible enclosure is at least compatible with a scenario selected from the group consisting of:
a. a single elliptical reflector with a single hole in the neck of the reflector, at least one part of the mounting system behind said reflector hole;
b. a single parabolic reflector with a single hole in the neck of said reflector, at least one part of the mounting system outside said reflector hole; and
c. an eele-enhanced® primary and retro reflector pair where the access ports includes at least one side hole along said optical lamp axis X, having a part of the mounting system located to one side of said axis Z; wherein one part of said mounting system is outside and one inside said reflector system and where when said lamp is inside said protective enclosure during at least one transport activity selected from a group comprising of:
i) delivery of said lamp to a reflector system with a respective lamp mounting system through said respective access port while said collapsible enclosure is collapsing progressively; and
ii) removal of said lamp from a respective reflector system and its respective lamp mounting system though said respective access port while said collapsed enclosure is progressively fully extending and delivery of said lamp to a suitable disposal site while substantially enclosed by said enclosure.

21. A protective lamp delivery system as in claim 19, wherein at least a portion of the inner surface of said protective enclosure is covered with a glue-like substance that adheres to the envelope after closure.

22. A protective lamp delivery system as in claim 19, wherein at least a portion of the inner surface of said protective enclosure is covered with at least one chemical substance having a characteristic selected from the group consisting of: to absorb and bind Hg.

23. A protective lamp delivery system as in claim 19, wherein mechanical contact between said enclosure and said lamp is limited said keyed mounting socket.

24. A protective lamp delivery system as in claim 19, wherein said protective enclosure has at least one ratcheting locking mechanism that prevents an unforced opening thereof.

25. A protective lamp delivery system as in claim 19, wherein said protective enclosure and said keyed mounting socket have a second set of keyed alignment features that are configured and dimensioned so that said lamp and said protective enclosure uniquely and removable interlock.
